(19) United States
(12) Patent Application Publication
(10) Pub. No.: US 2014/0326123 A1
(43) Pub. Date: Nov. 6, 2014

(54) Blade Device and System for a Mobile Shear

(71) Applicant: Charlie Hall, Bartow, GA (US)

(72) Inventor: Charlie Hall, Bartow, GA (US)

(21) Appl. No.: 14/207,978

(22) Filed: Mar. 13, 2014

Related U.S. Application Data
(60) Provisional application No. 61/781,418, filed on Mar. 14, 2013.

(51) Int. Cl. E02F 3/96; B23D 35/00; B23D 17/00

(52) U.S. Cl. CPC E02F 3/965; B23D 17/00; B23D 35/001
USPC 83/694

(57) ABSTRACT

Disclosed is a system and method providing an improved blade design and arrangement for a mobile shear. The blades in the upper and lower jaws of the shear may be removable, reversible and interchangeable, thereby providing the user with the ability to increase the life of the blades by rotating them when excessive wear is realized on the exposed edges.

### CROSS-REFERENCE TO RELATED APPLICATIONS

This application for patent claims priority under 35 U.S.C. §119(e) to, and incorporates by reference the entire contents of, U.S. provisional application entitled “BLADE DEVICE AND SYSTEM FOR A MOBILE SHEAR,” filed on Mar. 14, 2013 and assigned application Ser. No. 61/781,418.

### BACKGROUND

The present invention relates to a blade device and system for use in a mobile shear and, more particularly, to an improved blade system for use in the upper and lower jaws of a mobile shear that includes removable, reversible and interchangeable blades.

As is understood by one of ordinary skill in the art, mobile shears are used to convert scrap metal objects into smaller, more easily managed pieces. Mobile shears generally include a boom with a pair of hydraulically controlled jaws at its distal end. The jaws may include one or more blade components designed to take the wear that comes from crushing scrap metal.

Wear on the jaw blades of a mobile shear is expected. Once jaw blades exhibit significant wear, however, the efficiency of the mobile shear may be adversely affected as the blades are no longer capable of cleanly converting scrap metal into small pieces. Jaw blades presently known in the art, when excessively worn, are repaired in the field via “welding up” the worn areas of the blade before grinding them back down to a sharp edge.

The process of repairing worn blades in a mobile shear via welding and grinding is not only slow and expensive, but also often produces a blade edge that is not sufficiently sharp. Therefore, there is a need in the art for a replaceable and/or reversible blade device and system.

### DETAILED DESCRIPTION OF THE INVENTION

Embodiments and aspects of the present invention provide solutions to various needs in the art by providing an improved blade design and arrangement for a mobile shear. The blades in the upper and lower jaws of the shear may be removable, reversible and interchangeable, thereby providing the user with the ability to increase the life of the blades by rotating them when excessive wear is realized on the exposed edges.

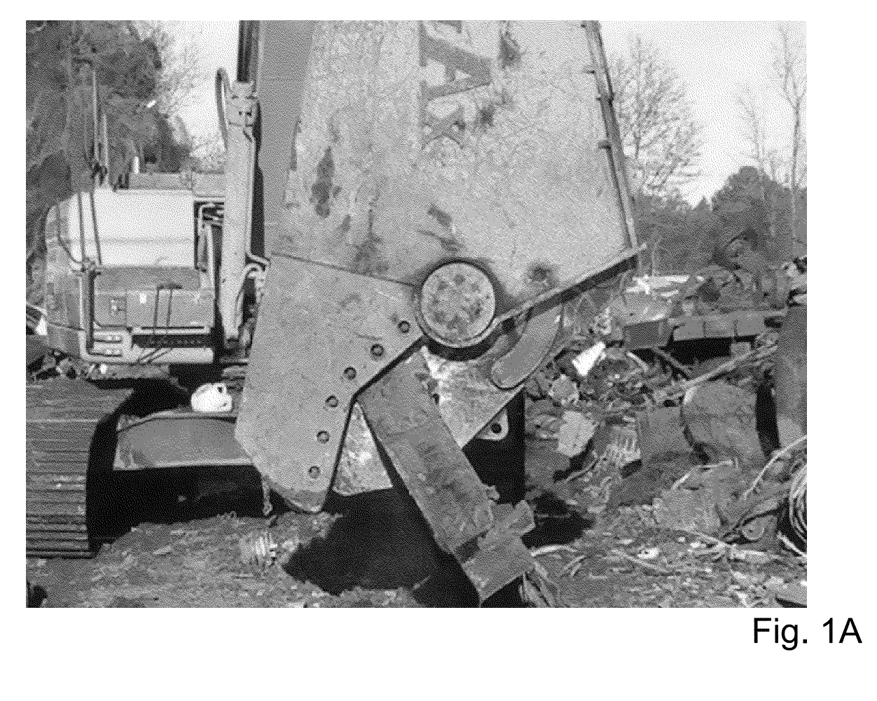

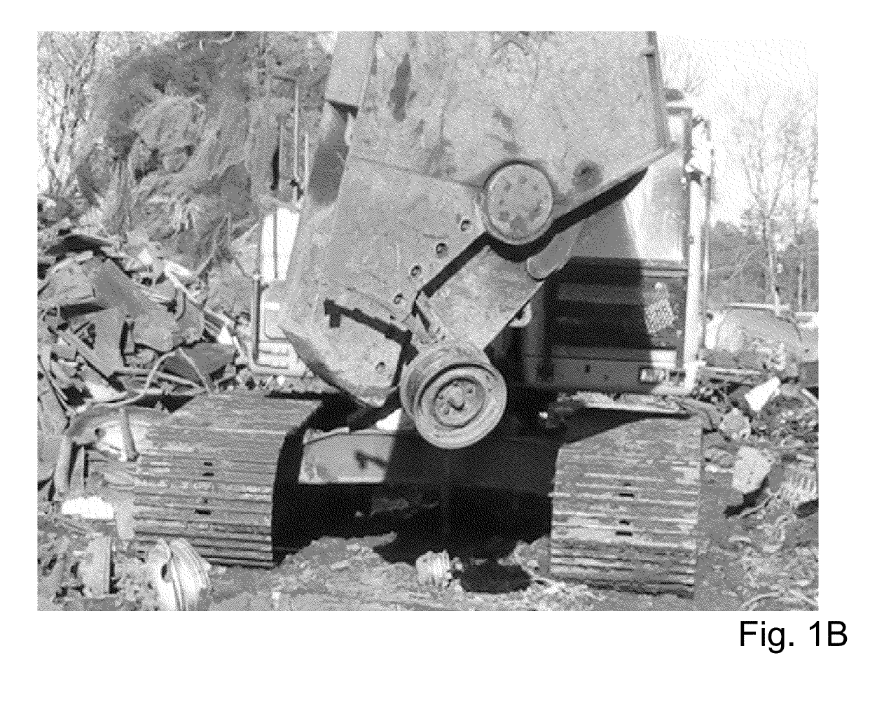

FIGS. 1A-1B depict a typical mobile shear known in the art. As can be seen in the FIG. 1 pictures, the jaws of the mobile shear are in the process of crushing a piece of scrap metal (an automobile axel in the FIG. 1B picture). As one of ordinary skill in the art recognizes, the scrap metal is consistently crushed within a certain wear area of the jaws. Consequently, the large plates that form the blades of the jaws require routine repair via welding up and grinding.

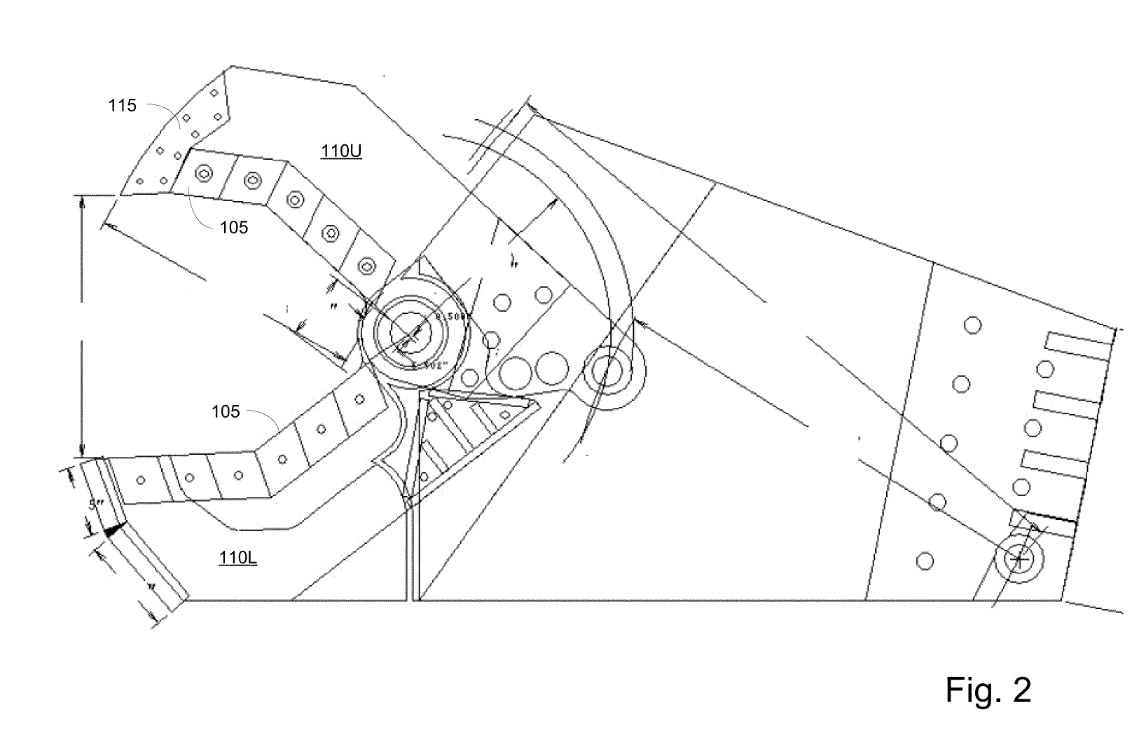

FIG. 2 is a drawing of an exemplary pair of mobile shear jaws with replaceable and reversible blade arrangement according to an embodiment of the invention. Notably, although the FIG. 2 depiction includes dimensions, the dimensions are included for exemplary purposes only and are not offered to limit the scope of the inventive systems and methods. It is envisioned that a replaceable and reversible blade arrangement may be provided according to any dimensions suitable for a given application. Moreover, a replaceable and reversible blade arrangement will not be limited to the particular dimensions, shapes, or quantities of blades that are depicted herein as the embodiments offered herein are for illustrative purposes only.

Returning to the FIG. 2 drawing, a series of trapezoidal blades 105 are arranged along the jawline of the upper and lower jaws 110U, 110L. Also, on the front “nose” of the upper jaw 110U, an incisor blade 115 is included. Advantageously, the trapezoidal blades 105 may be switched one with the other or flipped in place via unbolting and rebolting to the jaws 110. By doing so, new unworn edges of the trapezoidal blades 105 may be placed in position to be worn without the need for the blades to be welded up and ground. Similarly, the incisor blade 115 may also be removed from the jaw, flipped, and replaced such that new unworn edges are placed in position to receive wear.

Notably, although the exemplary embodiments included herein are described to include “trapezoidal” blades and incisor blades, the particular shapes of the blades are not meant to limit the scope of the invention. It is envisioned that any shaped blade may be used in an embodiment so long as, when excessively worn, the blade may either be swapped with another blade or flipped in its orientation such that a new edge is exposed for wear.

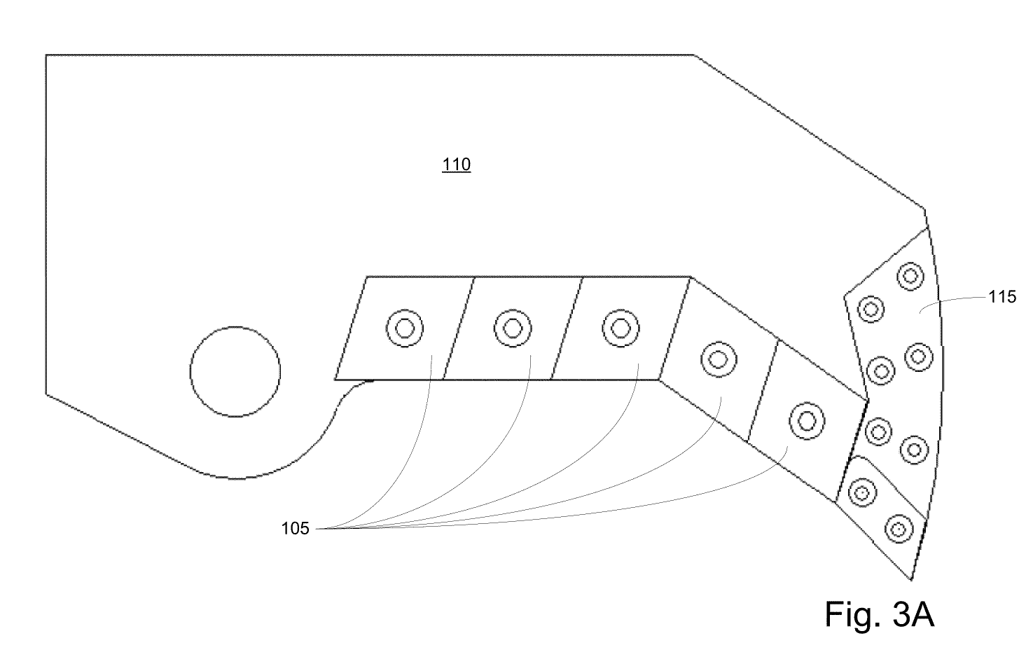

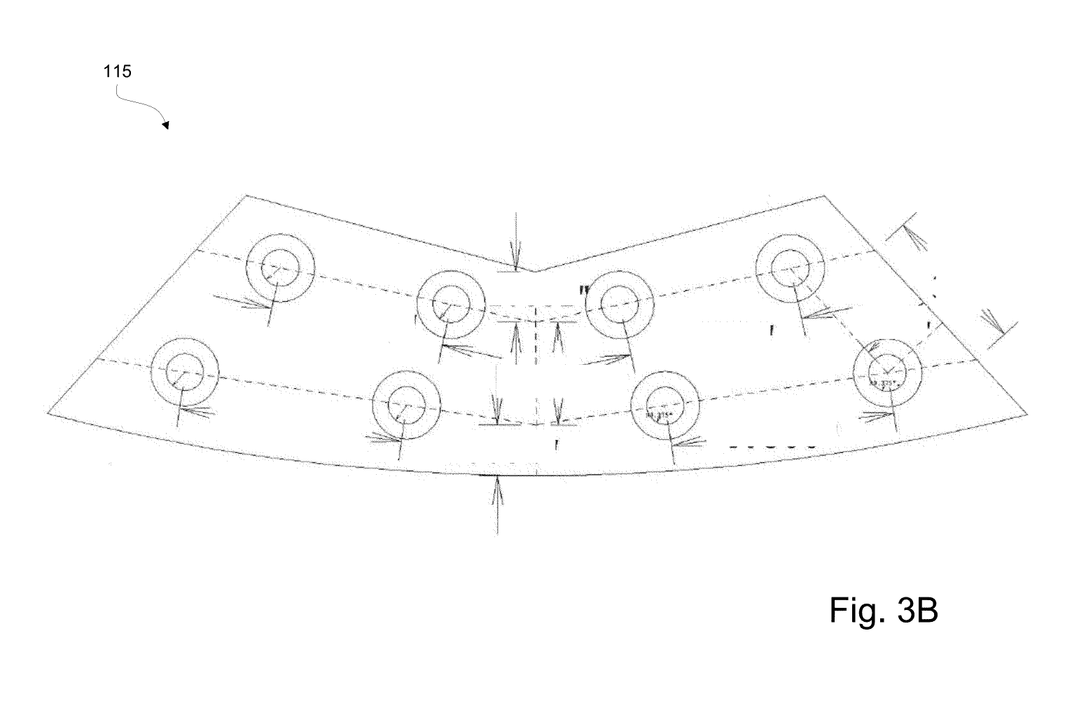

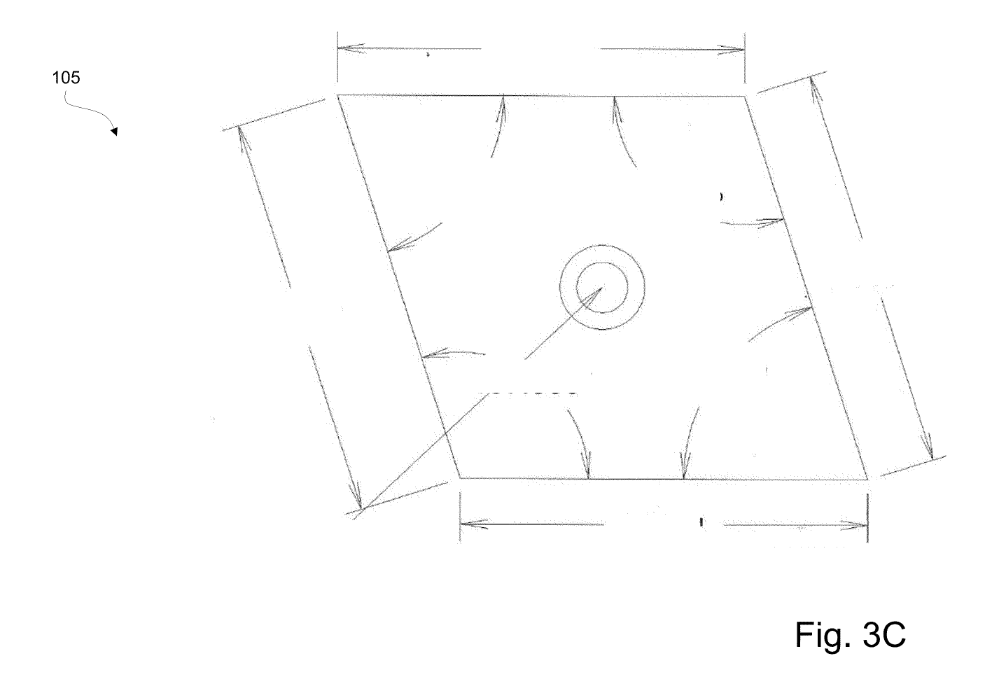

FIGS. 3A-3C are two-dimensional drawings of an exemplary jaw with replaceable and reversible blades according to the embodiment depicted in FIG. 2. As can be seen in the FIG. 3A drawing (as well as other drawings and figures included herein), the various blades included in the inventive system are configured to be held in communication with the jaw via one or more bolts or other fasteners. FIG. 3B depicts the exemplary incisor blade 115. FIG. 3C depicts the exemplary trapezoidal jawline blades 105.

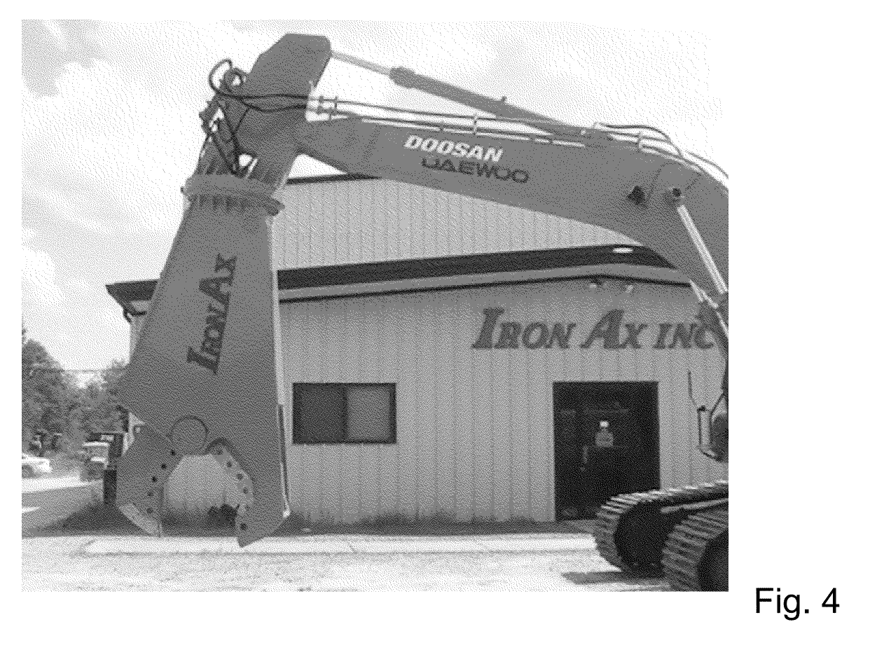

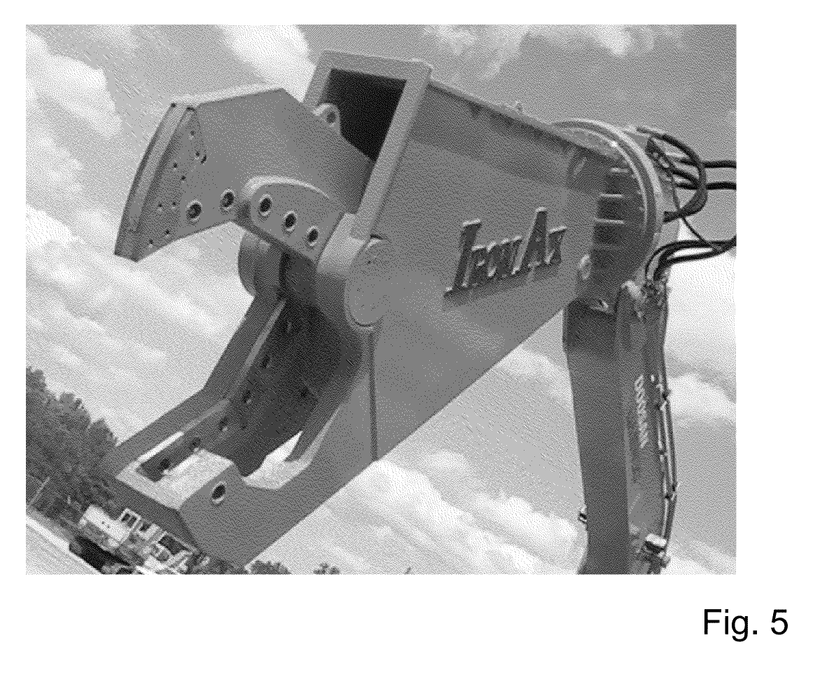

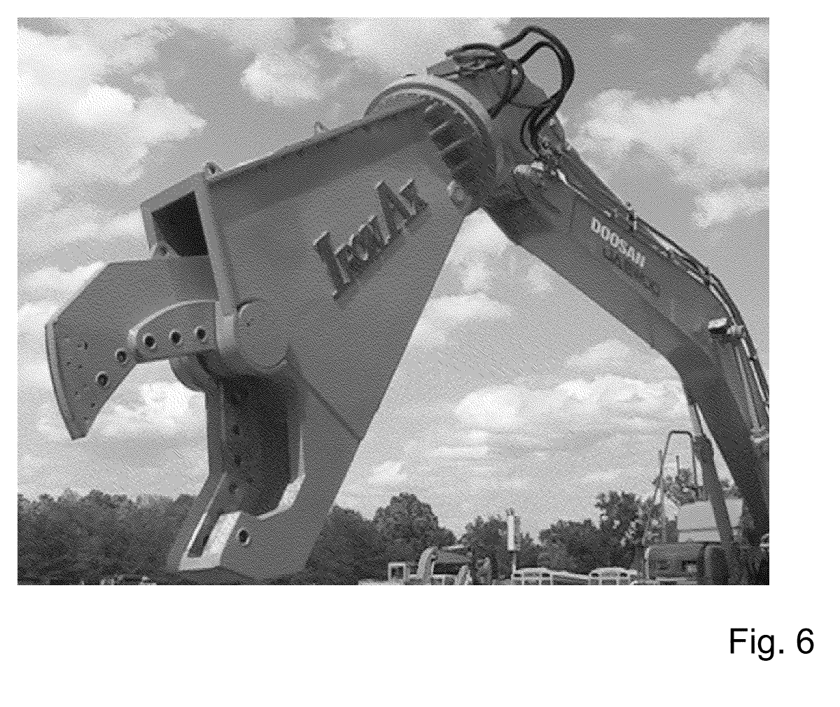

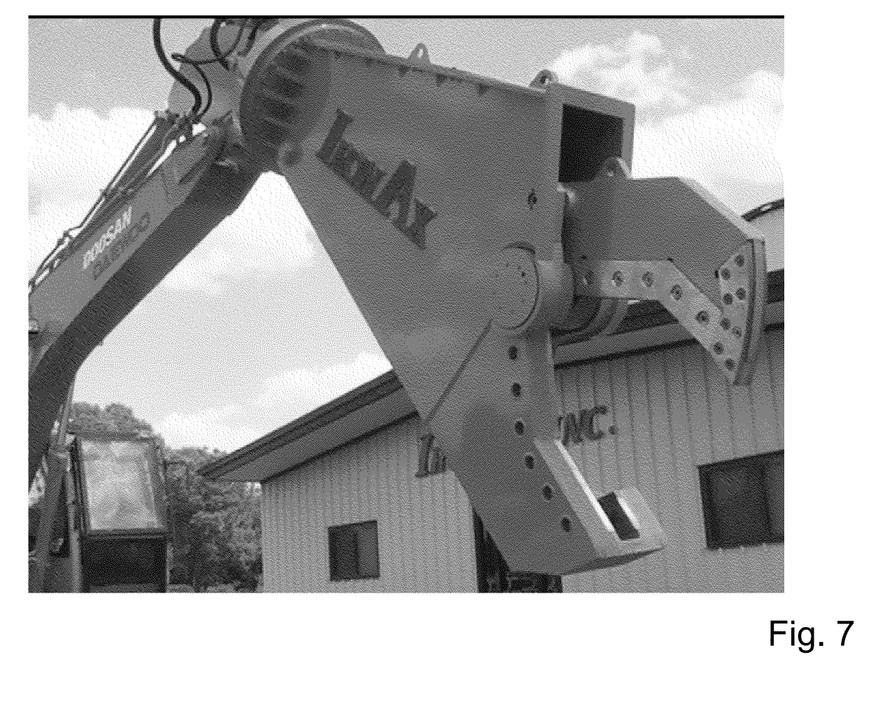

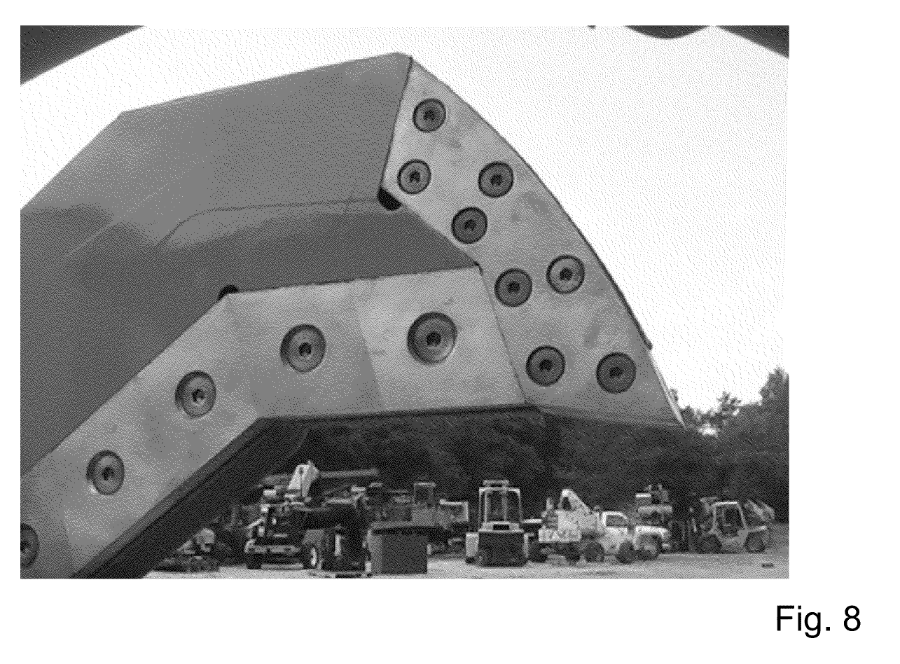

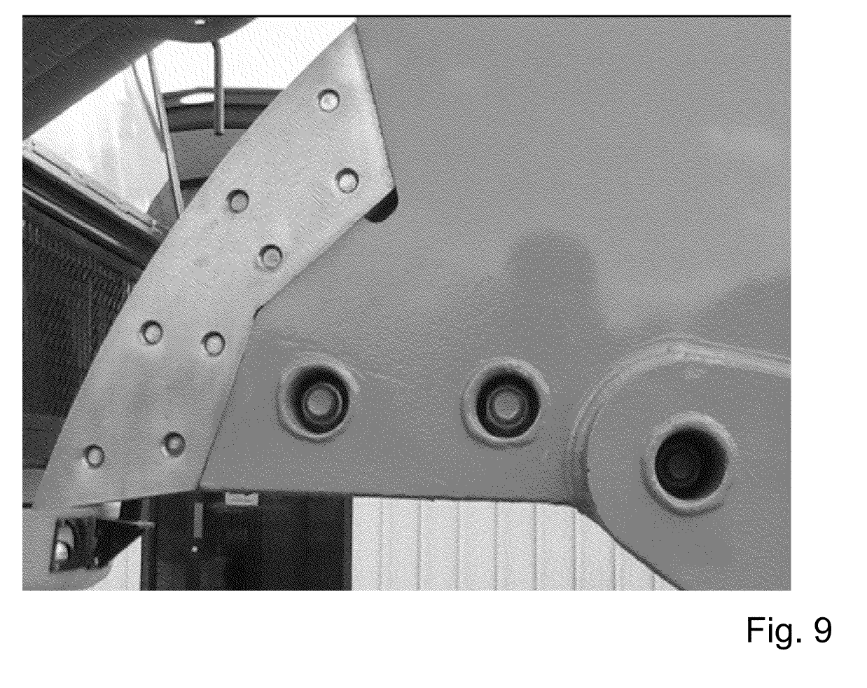

FIGS. 4-9 depict an exemplary embodiment of a blade design and system for a mobile shear according to the invention. In the Figures, a pair of incisor blades can be seen on the nose end of the upper jaw. As described above, the incisor blades may be “flippable” in place such that new wear edges previously protected are exposed for wear. Similarly, the incisor blades may be interchangeable, one with the other. Moreover, a series of jawline blades can also be seen in the figures. As described above, the jawline blades, by virtue of their shape may be flippable” in place such that new wear edges previously protected are exposed for wear. Similarly, the jawline blades may be interchangeable, one with the other.

Systems, devices and methods of the various inventions have been described using descriptions of embodiments thereof that are provided by way of example and are not intended to limit the scope of the disclosure. The described embodiments comprise different features, not all of which are required in all embodiments. Some embodiments utilize only some of the features or possible combinations of the features. Variations of embodiments that are described and embodiments that comprise different combinations of features noted in the described embodiments will occur to persons of the art.

Moreover, it will be appreciated by persons skilled in the art that systems, devices and methods of the inventions are not limited by what has been particularly shown and described herein and above. Therefore, although selected aspects have been illustrated and described in detail, it will be understood that various substitutions and alterations may be made therein without departing from the spirit and scope of the present invention. As such, the scope of the invention is limited only as it may be defined by a claim.

What is claimed is:

1. A reversible and replaceable blade system for use in a mobile shear, the system comprising:
an upper jaw component configured to receive a plurality of replaceable blades;
a lower jaw component configured to receive a plurality of replaceable blades; and
a plurality of replaceable blades, wherein one or more of the plurality of replaceable blades is configured to be reversed in orientation.
